(19) United States
(12) Patent Application Publication
(10) Pub. No.: US 2013/0196140 A1
(43) Pub. Date: Aug. 1, 2013

(54) COATED ARTICLE WITH ANTIREFLECTION COATING INCLUDING POROUS NANOPARTICLES, AND/OR METHOD OF MAKING THE SAME

(71) Applicants: Mark A. LEWIS, Ypsilanti, MI (US); Liang LIANG, Taylor, MI (US)

(72) Inventors: Mark A. LEWIS, Ypsilanti, MI (US); Liang LIANG, Taylor, MI (US)

(73) Assignee: Guardian Industries Corp., Auburn Hills, MI (US)

(21) Appl. No.: 13/361,754

(22) Filed: Jan. 30, 2012

(51) Int. Cl. B32B 3/10; B05D 5/06; B82Y 40/00

(52) U.S. Cl. 428/312.6; 427/165; 977/890

(57) ABSTRACT

In certain examples, a porous silica-based matrix may be formed. In an exemplary embodiment, using sol gel methods, a coating solution of or including metal alkoxides such as TEOS and porous nanoparticles such as mesoporous silica may be used to form a layer(s) of or including silica and porous nanoparticles in a solid matrix directly or indirectly on a glass substrate. The coated article may be heat treated (e.g., thermally tempered). The layer of the porous silica-based matrix may be used as a broadband anti-reflective coating.

Certain example embodiments of this invention relate to a method of making an antireflective (AR) coating supported by a glass substrate. The AR coating includes, in certain exemplary embodiments, porous metal oxide(s) and/or silica, and may be produced using a sol-gel process. The porosity of the coating may be controlled by adding porous nanoparticles (e.g., nano- and/or meso-porous nanoparticles of or including silica, titanium oxide, zinc oxide, iron oxide, aluminum oxide, tungsten oxide, boron oxide, or zirconium oxide) or other nano- and/or meso-porous nanoparticles to the coating solution, such that the coating comprises a porous nanoparticle and metal oxide and/or silica-based matrix. Various nano- and/or meso-porous materials may make it possible to design thin film AR coatings with a greater selection of pore size, porosity, and/or pore distribution. The coated article may then be heat treated (e.g., thermally tempered). The AR coating may, for example, be deposited on glass used as a substrate or superstrate for the production of photovoltaic devices or other electronic devices, although it also may used in other applications.

### BACKGROUND AND SUMMARY OF EXAMPLE EMBODIMENTS

Glass is desirable for numerous properties and applications, e.g., based on its optical clarity and overall visual appearance. It would be desirable to optimize certain optical properties (e.g., light transmission, reflection and/or absorption) for certain example applications. For instance, in some cases, reduction of light reflection from the surface of a glass substrate may be desirable for storefront windows, electronic devices, monitors/screens, display cases, photovoltaic devices such as solar cells, picture frames, other types of windows, and so forth.

Photovoltaic devices such as solar cells (and modules therefor) are known in the art. Glass is an integral part of most common commercial photovoltaic modules, including both crystalline and thin film types. A solar cell/module may include, for example, a photoelectric transfer film made up of one or more layers located between a pair of substrates. One or more of the substrates may be glass, and the photoelectric transfer film (typically semiconductor) may be used for converting solar energy to electricity. Example solar cells are disclosed in U.S. Pat. Nos. 4,510,344, 4,806,436, 6,506,622, 5,977,477, and JP 07-122764, the disclosures of which are all hereby incorporated herein by reference in their entireties.

Substrate(s) in a solar cell/module are often made of glass. Incoming radiation passes through the incident glass substrate of the solar cell before reaching the active layer(s) (e.g., photoelectric transfer film such as a semiconductor) of the solar cell. Radiation that is reflected by the incident glass substrate does not make its way into the active layer(s) of the solar cell, thereby resulting in a less efficient solar cell. In other words, it would be desirable to decrease the amount of radiation that is reflected by the incident substrate, thereby increasing the amount of radiation that makes its way through the incident glass substrate (the glass substrate closest to the sun) and into the active layer(s) of the solar cell. In particular, the power output of a solar cell or photovoltaic (PV) module may be dependent upon the amount of light, or number of photons, within a specific range of the solar spectrum, that passes through the incident glass substrate and reach the photovoltaic semiconductor.

Because the power output of the module may depend upon the amount of light within the solar spectrum that passes through the glass and reaches the PV semiconductor, attempts have been made to boost overall solar transmission through the glass used in PV modules. One attempt is the use of low-iron or “iron-free” or “clear” glass, which may increase the amount of solar light transmission when compared to regular float glass, through absorption reductions. Such an approach may or may not be used in conjunction with certain embodiments of this invention.

In certain example embodiments of this invention, an attempt to address the aforesaid problem(s) is made using an antireflective (AR) coating on a glass substrate (the AR coating may be provided on either side, or both sides, of the glass substrate in different embodiments of this invention). An AR coating may increase transmission of light through the light incident substrate, and thus increase the power and efficiency of a PV module in certain example embodiments of this invention.

In many instances, glass substrates have an index of refraction of about 1.52, and typically about 4% of incident light may be reflected from the first surface. Single-layered coatings of transparent materials such as silica and alumina having a refractive index of equal to the square root of that of glass (e.g., about 1.23 +/−10%) may be applied to minimize or reduce reflection losses and enhance the percentage of light transmission through the incident glass substrate. The refractive indices of silica and alumina are about 1.46 and 1.6, respectively, and thus these materials alone in their typical form may not meet this low index requirement in certain example instances.

In certain example embodiments of this invention, pores are formed in such materials or the like. In particular, in certain example embodiments of this invention, porous inorganic coated films may be formed on glass substrates in order to achieve broadband anti-reflection (AR) properties. Because refractive index is related to the density of coating, it may be possible to reduce the refractive index of a coating by introducing porosity into the coating. Pore size and distribution of pores may significantly affect optical properties. Pores may preferably be distributed homogeneously in certain example embodiments, and the pore size of at least some pores in a final coating may preferably be substantially smaller than the wavelength of light to be transmitted. For example, it is believed that about 53% porosity (+/−about 10%, more preferably +/−about 5% and sometimes even +/−2%) may be required in order to lower the refractive index of silica-based coatings from about 1.46 to about 1.2 and that about 73% porosity (+/−about 10%, more preferably +/−about 5% or and sometimes even +/−2%) may be required to achieve alumina based coatings having about the same low index.

The mechanical durability of coatings, however, may be adversely affected with major increases in porosity. Porous coatings also tend to be prone to scratches, mars, etc. Thus, it will be appreciated that it would be desirable to provide AR coatings that are capable of realizing a desired porosity without significantly adversely affecting mechanical durability of the AR coatings, and/or methods of making the same.

Certain example embodiments of this invention may relate to a method of making a coated article including a broadband anti-reflective coating comprising porous silica, directly or indirectly, on a glass substrate. In certain instances, the method may comprise forming a coating solution comprising a silane, porous nanoparticles, and a solvent; forming a coating, directly or indirectly, on the glass substrate by disposing the coating solution on the glass substrate; and drying the coating and/or allowing the coating to dry so as to form a coating comprising silica and a porous nanoparticle-based matrix on the glass substrate so as to form an anti-reflective coating comprising a porous silica-based matrix on the glass substrate.

Certain example embodiments relate to a method of making an anti-reflective coating, the method comprising: providing a coating solution comprising at least a metal oxide, mesoporous nanoparticles, and a solvent; disposing the coating solution on a glass substrate so as to form a coating comprising a metal oxide and mesoporous nanoparticle-based matrix, so as to form a coating comprising a porous metal oxide.

Further example embodiments relate to a coated article comprising a glass substrate with an anti-reflective coating disposed thereon; wherein the anti-reflective coating comprises porous silica, and comprises pores arising from the spaces between atoms and/or molecules, as well as pores arising from the porous nature of the porous nanoparticles.

Still further example embodiments relate to a method of making a coated article including an anti-reflective coating comprising porous silica, directly or indirectly, on a glass substrate. The method comprises: forming a coating solution comprising a silane, mesoporous nanoparticles comprising silicon oxide, and a solvent; forming a coating, directly or indirectly, on the glass substrate by disposing the coating solution on the glass substrate; drying the coating and/or allowing the coating to dry so as to form a coating comprising silica and a matrix comprising the mesoporous nanoparticles on the glass substrate; and heat treating the glass substrate with the coating thereon, so as to form an anti-reflective coating comprising a silica-based porous matrix on the glass substrate.

In certain example embodiments, a coating may include a porosity defined by first and second pore sizes, the first pore size being created as a result of a geometric package of mesoporous silica nanoparticles and metal oxide particles in the matrix, and the second pore size being created by virtue of a pore size of the mesoporous silica nanoparticles.

### BRIEF DESCRIPTION OF THE DRAWINGS

FIG. 1 shows a cross-sectional view of a single-layered anti-reflective coating according to certain embodiments;

FIGS. 2(a)-(e) illustrate different example surface morphologies of porous nanoparticles;

FIG. 3 illustrates an example reaction between a porous nanoparticle and a metal oxide-inclusive compound to produce an example of a porous nanoparticle- and metal oxide-based matrix;

FIG. 4 illustrates an example condensation reaction between mesoporous silica nanoparticles and a silane-inclusive compound to produce an example porous silica-based matrix;

FIG. 5 shows a cross-sectional view of a coating comprising a network of porous nanoparticles and a silane-based compound according to certain example embodiments;

FIG. 6 is a partially schematic cross-sectional view of an anti-reflective coating comprising a metal oxide-based compound with pores created by the spacing between the molecules, as well as by the pores created by virtue of the porous nanoparticle materials, according to certain example embodiments;

FIGS. 7(a)-(f) illustrate various example morphologies of micelles developed by surfactant(s);

FIGS. 8(a)-(b) illustrate an example surface morphology of a porous nanoparticle comprising a hexagonal structure;

FIGS. 9(a)-(b) illustrate an example surface morphology of a porous nanoparticle comprising a cubic structure;

FIGS. 10(a)-(b) illustrate an example surface morphology of a porous nanoparticle comprising a lamellar structure;

FIG. 11 illustrates an example surface morphology of a porous nanoparticle comprising a tubular structure, and an example mechanism of synthesis; and

FIG. 12 is a flowchart illustrating an example method for making an improved anti-reflective coating according to certain example embodiments.

### DETAILED DESCRIPTION OF THE INVENTION

Certain example embodiments relate to antireflective (AR) coatings that may be provided for coated articles used in devices a variety of window, electronic device, and/or other applications such as, for example, photovoltaic devices, storefront windows, display cases, picture frames, greenhouses, monitors, screens, and/or the like. In certain example embodiments (e.g., in photovoltaic devices), the AR coating may be provided on either the light incident side and/or the other side of a substrate (e.g., glass substrate), such as a front glass substrate of a photovoltaic device. In other example embodiments, the AR coatings described herein may be used in the context of sport and stadium lighting (as an AR coating on such lights), and/or street and highway lighting (as an AR coating on such lights) in certain example instances.

In photovoltaic device applications, for example, an improved anti-reflection (AR) coating may provided on a light incident glass substrate of a solar cell or the like. This AR coating may function to reduce reflection of light from the glass substrate, thereby allowing more light in the solar spectrum to pass through the incident glass substrate and reach the photovoltaic semiconductor so that the photovoltaic device (e.g., solar cell) can be more efficient. The coating may be provided on a glass substrate, superstrate, and/or in any other suitable location in different instances.

In certain example embodiments, porous inorganic AR coatings may be made by (1) a porogen approach using micelles as a template in a metal (e.g., Si, Al, Ti, etc.) alkoxide matrix; (2) inorganic or polymeric particles with metal alkoxides as binders; (3) inorganic nanoparticles with charged polymers as binder, and/or (4) hollow silica nanoparticles.

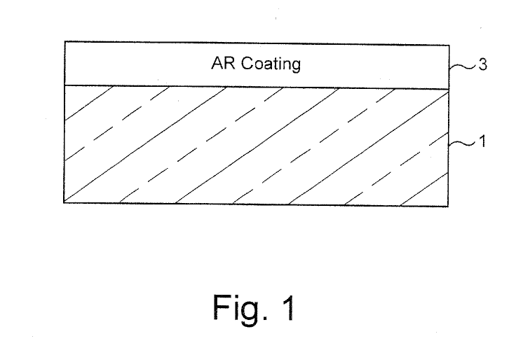

Referring now more particularly to the accompanying drawings in which like reference numerals indicate like parts throughout the several views, FIG. 1 is a side cross-sectional view of a coated article according to an example non-limiting embodiment of this invention. The coated article includes substrate 1 (e.g., clear, green, bronze, or blue-green glass substrate from about 1.0 to 10.0 mm thick, more preferably from about 1 .0 mm to 3.5 mm thick), and anti-reflective coating 3 provided on the substrate 1 either directly or indirectly. The anti-reflective coating 3 may comprise a single or multiple porous silica-based matrix. Example methods of making a porous silica-based anti-reflective coating 3 are described in detail herein.

It has been found that in certain examples, the pore size and/or porosity of the particles in a coating may play a role in tuning the optical performance of AR coated glass substrates. In certain cases, it has been found that when pore sizes in the coating that are less than about 50 nm (e.g., ranging from about 1 to 50 nm, more preferably from about 2 to 25 nm, and most preferably from about 2.4 nm to 10.3 nm), the porosity of the corresponding films can vary widely. In certain examples, the porosity of a coating is the percent of the coating that is void space. For example, when the pore size is from about 2.4 to 10.3 nm, the porosity may vary over a range of about 10% or more—e.g., from about 27.6% to 36%. Higher porosity may in some cases yield films with lower indices of refraction, but with tradeoffs in (e.g., compromised) durability. Furthermore, experimental data obtained from changing the size and ratio of different spherical particles in conjunction with the amount of binder used that fills in the geometrical space between particles may also indicate that the film structure and porosity of an AR coating may have an effect on optical performance. In certain example embodiments, the porosity of a layer may be dependent upon (1) spaces between the molecules comprising the coating, and/or (2) pores within the molecules themselves. Thus, it may be advantageous to control the film structure and/or porosity of an AR coating by controlling one or both of the aforesaid characteristics of the coating in order to produce desired optical properties. Accordingly, there is provided a technique of creating a porous silica-based matrix that may achieve improved AR optical performance and/or film durability.

In certain example embodiments, the tailoring of pore size and/or porosity of AR coated films may be achieved by controlling the size of surfactants, polymers, and/or nanoparticles. More particularly, in certain examples, the pore size and/or porosity of an AR coating may be modified by introducing porous nanoparticles such as mesoporous nanoparticles of or including silicon oxide, titanium oxide, etc., inside a silica-based matrix of at least one of the layer(s) of the coating (or most/all of the coating). In certain example embodiments, porous nanoparticles (e.g. nano- and/or meso-porous) materials may exhibit pore sizes ranging from about 1 to 100 nm, more preferably from about 2 to 50 nm, and most preferably from about 2 to 25 nm; although they may be larger or smaller according to different example embodiments. Porous nanoparticles may demonstrate different pore morphologies, for example, hexagonal, bi-continuous cubic, and/or lamellar morphologies, in certain examples. The morphology of porous nanoparticles materials may be tailored by the chemical structure of surfactants and/or the nature of the process, in some cases. Furthermore, the surface(s) of porous materials may be modified to fit various applications, according to different embodiments.

In certain example embodiments, the pore structure created by virtue of the size and shape of porous nanoparticles additives as well as that created by the spaces between the molecules may improve the capability to control the pore size and/or porosity of the coating prior to and/or following heat treatment (e.g., thermal tempering).

It has advantageously been found that in certain example embodiments, adding nano- and/or meso-porous metal oxide nanoparticles (e.g., oxides of or including any of Si, Ti, Zn, Fe, Al, W, B, Zr, and/or the like) to a sol gel-based metal (e.g., Si, Al, Ti, etc.) oxide/alkoxide system may result in an improved AR coating.

For example, in certain exemplary embodiments, nanoporous and/or mesoporous nanoparticles may be made from silicate materials. In certain embodiments, these materials may have a refractive index close to that of a glass substrate. In other example embodiments, porous nanoparticles may also be prepared from metal oxides and/or transition metal oxides, such as oxides of or including any of Si, Ti, Al, Fe, V, Zn, V, Zr, Sn, phosphate, etc. Certain example embodiments described herein relate to a method of making such an improved AR coating.

In certain example embodiments, AR coatings may comprise porous materials (e.g., mesoporous nanoparticles). In certain examples, sol gel technology with metal oxides and/or alkoxides (e.g. silanes, other metal oxides, etc.) may be used to create AR coatings for glass substrates. In certain cases, the desired porosity and/or pore size may be generated by the geometric package of porous nanoparticles and/or the intrinsic pore structure of mesoporous materials.

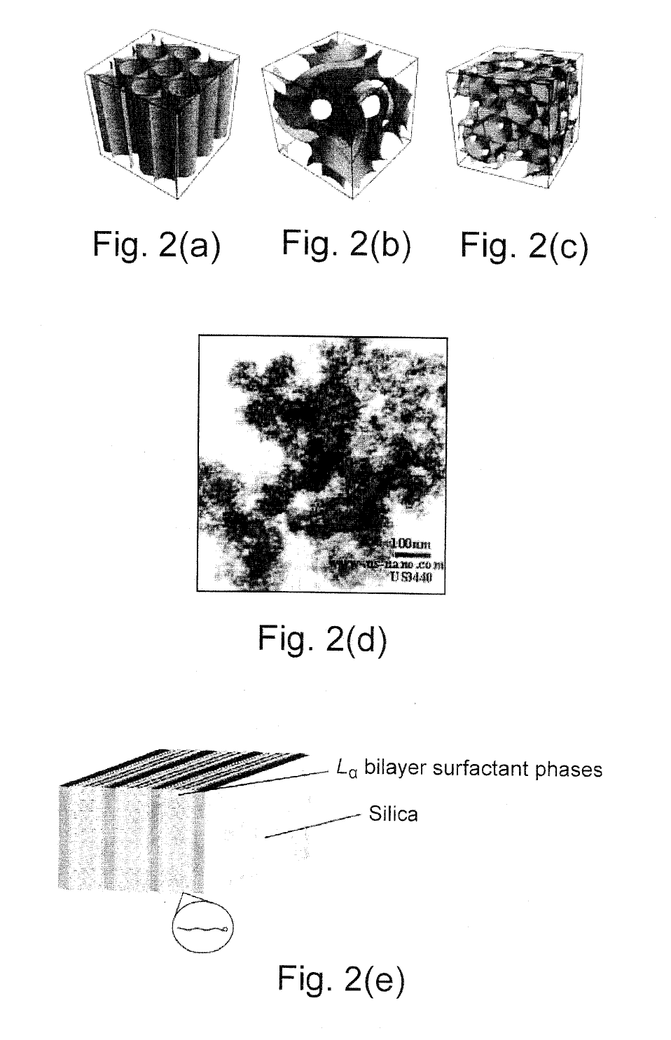

FIG. 2(a)-2(c) illustrate various microstructures in mesoporous materials. FIG. 2(a) illustrates an example microstructure with a hexagonal morphology. FIG. 2(b) illustrates an example microstructure with a bi-continuous cubic morphology. FIG. 2(c) also illustrates an example microstructure with a cubic morphology. FIG. 2(d) is a TEM (transmission electron microscope) image of porous amorphous silica nanoparticles with a pore size of 15-20 nm, and a specific surface area of 640 m²/g. FIG. 2(e) illustrates an example microstructure with a lamellar morphology. In certain instances, porous nanoparticles may be available from America Dye Inc., and US Nano-Materials Inc., respectively.

In certain example embodiments, “nanoporous materials” and/or “mesoporous materials” as disclosed herein may refer to materials such as nanoporous and/or mesoporous nanoparticles with varying pore sizes and varying surface morphologies. In certain example embodiments, by using porous nanoparticles in an AR coating (e.g., a silicon oxide-based AR coating), the pore size and/or porosity of the AR coating may advantageously be adjusted more precisely and/or over a wider range. Furthermore, in certain example embodiments, the refractive index of the coating may be tuned by choosing a desired porosity, but obtaining said porosity with at least two types of pore sizes—e.g., pore sizes generated by the space(s) between molecules, and pore sizes created inherently in the coating from the porous nanoparticles in the matrix. In certain instances, making a coating having a particular porosity by using varying sizes/types of pores may result in a coating with improved durability. For instance, in certain example embodiments, the average width of a pore may be less than about 2 nm, more preferably less than about 1 nm, and in certain embodiments, less than about 0.5 nm.

Moreover, in certain example embodiments, porous nanoparticles with a particular pore size(s) and/or shape(s) may be chosen based on the pore structure(s) and/or size(s) desired for the final coating. In certain instances, this may advantageously enable the refractive index of an AR coating to be more finely tuned. In certain example embodiments, other types of porous materials, structures or particles that include porous materials may replace or be used in addition to or instead of the porous nanoparticles in order to form the pores.

Porous nanoparticles may be desirable in certain embodiments because they may enable the pore size and/or porosity of the AR coating to be tuned by both or either (1) the geometric package of porous nanoparticles (e.g., the size of pores between molecules in the matrix, etc.), and/or (2) the pore size of the porous nanoparticles (e.g., the size of the pores in the porous materials). In certain examples, this may permit control over pore size, and may enable an AR coating with more than one pore size to be formed. In certain example embodiments, this may advantageously permit one to tune the porosity of the AR coating, and thus the refractive index, to a finer degree. In certain instances, the pore size(s) (e.g., void space/volume) may be controlled so as to tune the antireflective performance (e.g., tuning the refractive index) and/or improving the durability of the coating and/or coated article. In certain example embodiments, through the use of porous nanoparticles, the optical performance of an AR coating (e.g., formed via sol gel) may be improved and/or become more controllable. In certain cases, this may be due to the introduction of these porous nanostructures into the coated layer.

In certain cases, as FIGS. 2(a)-(c) indicate, porous nanoparticles materials may be particles with different surface morphologies. Porous nanoparticles may have unique properties, which may make them potentially useful in many applications in nanotechnology, electronics, optics, other fields of materials science, and potentially in architectural fields. Porous nanoparticles alone may not be reactive, in certain example embodiments. These porous materials can also cover a wide range of pore sizes to accommodate fine tuning the structure of the coating to have the desired optical and/or durability properties.

In certain example embodiments, porous nanoparticles may be mixed with metal oxides and/or alkoxides in order to form a sol gel coating solution that may be deposited on a substrate through sol gel-type methods (e.g., casting, spin coating, dipping, curtain and roller, spray, electro-deposition, flow coating, and/or capillary coating, etc.). An example of a typical sol gel process is disclosed in U.S. Pat. No. 7,767,253, which is hereby incorporated by reference.

In certain example embodiments, a coating solution may be made by mixing a silane-based compound, porous nanoparticles, and an organic solvent. In certain example embodiments, the organic solvent may be of or include a low molecular weight alcohol such as n-propanol, isopropanol, ethanol, methanol, butanol, etc. However, in other embodiments, any organic solvent, including higher-molecular weight alcohols, may be used.

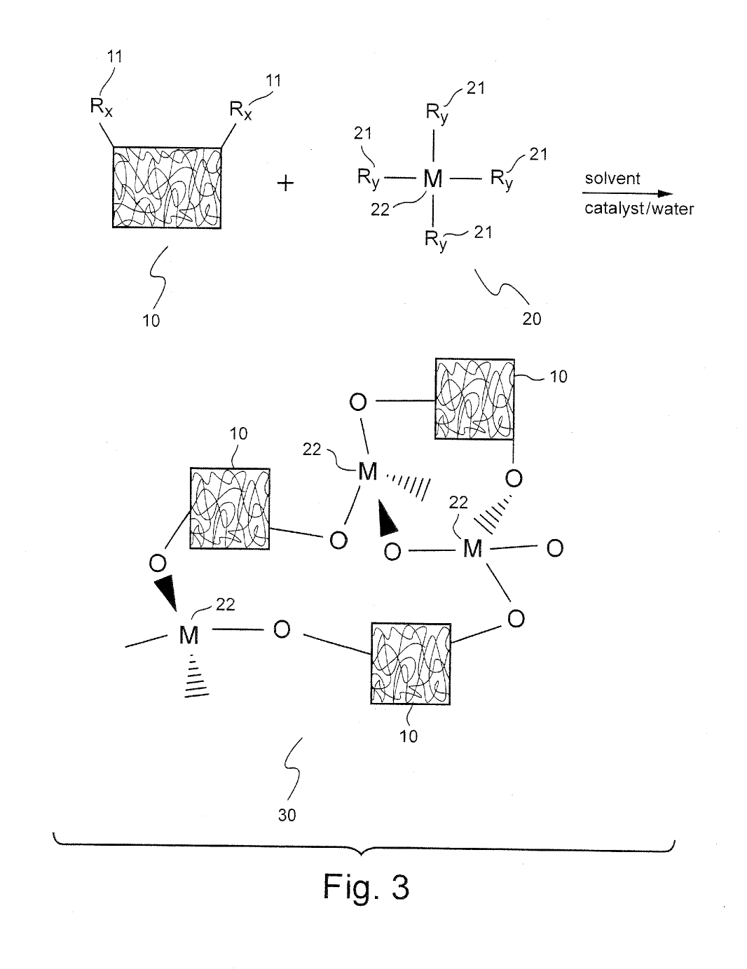

An example process for making an AR coating with porous nanoparticles is illustrated in FIG. 3. More particularly, FIG. 3 shows the process of making a coated article comprising an AR coating from at least porous nanoparticles and metal alkoxide.

In the FIG. 3 example, an example method of making a metal (e.g., Si, Ti, Al, etc.) oxide and porous nanoparticle-based matrix is shown. Porous nanoparticle 10 has functional groups 11 comprising Rx. In certain embodiments, the Rx groups may be of or include a similar compound. In other example embodiments, some Rx groups may be different from each other. In an exemplary example embodiment, functional group(s) 11 may be of or include hydroxyl groups (e.g., OH). However, functional groups 11 may alternatively or additionally comprise any material that will react with metal oxide 20.

Metal oxide/alkoxide compound 20 may comprise metal M 22, and groups 21 comprising Ry. In certain example embodiments, groups Ry may be of or include a similar compound. In other example embodiments, some groups Ry may be different from each other. An example of an Ry group is OR, or oxygen atoms bonded to carbon-based compounds. However, groups 21 may comprise any material that will react with, or enable compound 20 to react with, functional groups 11 of porous nanoparticle(s) 10.

In certain example embodiments, metal oxide compound 20 may be hydrolyzed. In certain examples, the hydrolysis reaction may cause some groups 21 comprising Ry to become hydroxyl groups. In other examples, other reactions may cause at least portions of the Ry groups (e.g., the carbon-based compounds R may be split from an oxygen that is bonded to metal M) to cleave from the metal M atoms.

In certain examples, the hydrolyzed metal oxide-based compound 20 may be mixed with molecules 10 (e.g., porous nanoparticles 12 comprising functional groups 11), and solvent, and optionally catalysts, water, and/or further solvents, to make network 30. In certain example embodiments, network 30 (before and/or after any drying steps) may comprise porous nanoparticles 10 and metal M 22 based network, wherein the porous nanoparticles and the metal atoms are bonded via oxygen atoms (e.g., from the Rx and/or Ry groups).

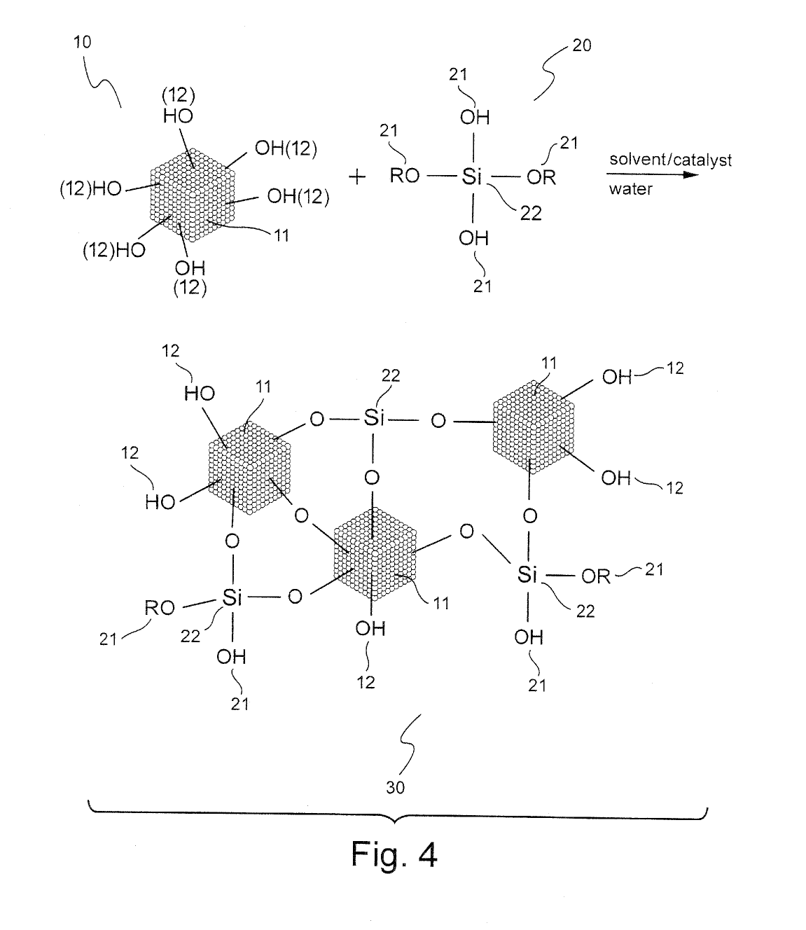

A further example method of making a silica and porous nanoparticle (e.g., mesoporous silica) based matrix is shown in FIG. 4. In FIG. 4, metal oxide 20 comprises a hydrolyzed silane-based compound, and porous nanoparticles 10 comprise mesoporous silica 11 with functional groups 12 comprising at least one (or more) hydroxyl group(s) (e.g., OH). Silane-based compound 20 is mixed with porous nanoparticles 10, and (e.g., through a condensation reaction) a silica and mesoporous nanoparticle based matrix is produced. However, in some embodiments, the porous nanoparticles may have functional groups other than OH groups attached thereto. Porous nanoparticles alone may not be reactive, in certain example embodiments. However, the hydroxyl groups bonded to the porous nanoparticles structure(s) may react with a silane-based compound. The silane-based compound can be any compound comprising silicon with e.g., four reaction sites. The silane-based compound may comprise Si bonded to OH groups, OR groups (e.g., where R is a carbon-based compound such as a hydrocarbon), or a mix of OH and OR groups. In certain example embodiments, the silane-based material may comprise silicon atoms bonded to four “OR” groups, and upon hydrolysis, at least some of the R groups will be replaced by H atoms so as to facilitate the reaction between the silicon-based compound and the functional group of the porous nanoparticles.

In an exemplary embodiment, a coating composition may comprise TEOS, mesoporous silica nanoparticles with at least one (or more) hydroxyl groups, and an organic solvent such as ethanol, water and catalyst (acid, base, and/or F⁻). The coating solution may be deposited on a glass substrate via traditional sol gel coating methods, for example, dipping, spinning, curtain and roller, etc. Hydrolysis of metal alkoxides could be initiated by catalyst (acid or base) and water. Condensation of hydrolyzed metal alkoxides with functional porous nanoparticles and self-condensation of hydrolyzed metal alkoxides may occur prior to the formation of a sol, or in the sol. In this example, a reactive silane may be generated by the hydrolysis of TEOS. Then, at least some of the OH and/or OR sites of the silane may react with the hydroxyl functional groups of the porous nanoparticles in a condensation reaction. A network comprising silica bonded to the porous nanoparticles (here, mesoporous silica) via oxygen results in certain embodiments. Specifically, one or more mesoporous silica molecules with one or more hydroxyl groups combine with hydrolyzed TEOS 20 in a condensation reaction to produce a network 30 of mesoporous silica and TEOS.

Although TEOS is used as an example of a silica-based compound that may be used to form a silica-based network, any organic compound with silica, particularly with silicon and/or silane with four reaction sites, may be used in certain example embodiments. Furthermore, porous layers based on other metal oxides/alkoxides may be made this way as well.

In certain example embodiments, the process of forming a solid silica and porous nanoparticle based network can be implemented by evaporation-induced self-assembly (EISA), with suitable solvents (e.g., low molecular weight organic solvents). Any by-products or unused reactants, such as water, solvent, and/or hydrocarbons (e.g., from the R group of the silane and/or the solvent), that do not evaporate on their own as the coating is formed/immediately after, may be evaporated during an optional drying step. In certain example embodiments, after the coating is formed, the coating may be dried. In certain example embodiments, this drying may be performed in an oven and/or in any appropriate environment. The drying may be performed at a temperature of from about room temperature to 100° C., more preferably from about 50 to 80° C., and most preferably at a temperature of about 70° C. The drying may be performed for anywhere from a few seconds to a few minutes, more preferably from about 30 seconds to 5 minutes, and most preferably from about 1 to 2 minutes (at a temperature around 70° C.).

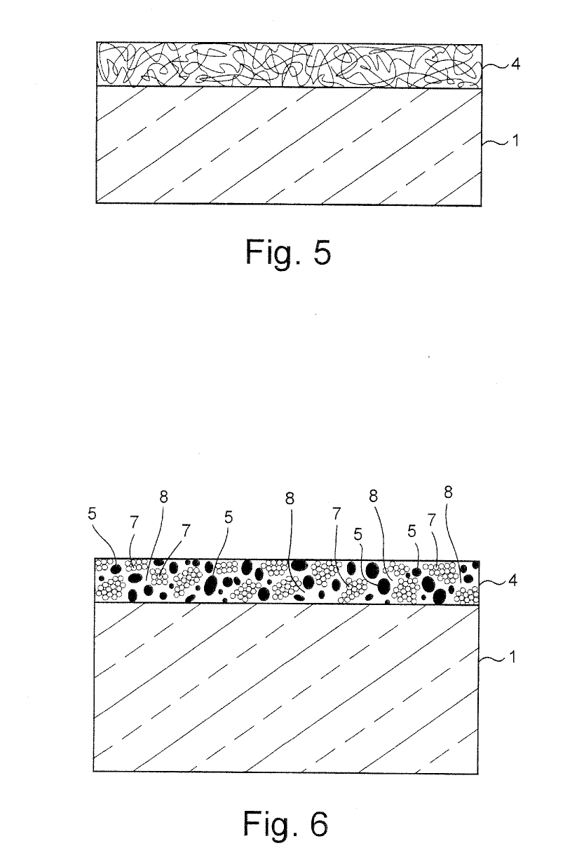

FIG. 5 illustrates a cross-sectional view of an example coated article comprising a silica-based layer 4 after it has dried and/or heat-treated. In certain example embodiments, the porous nanoparticles are essentially trapped in a solid silica-based matrix after drying and/or heat treatment. Depending on the type of porous nanoparticles used, the size and shape of the pores, as well as the surface morphology of nanoparticles in the matrix, may be substantially closed and/or spherical, and/or a mix of the two (e.g., if more than one type of porous nanoparticle(s) are used). At this stage, after drying, but prior to any heat treating/thermal tempering, the amount of solids in the coating in certain example embodiments may be from about 0.2 to 2%, more preferably from about 0.5 to 1%, and most preferably from about 0.6 to 0.7% (by weight).

In certain example embodiments, the preferable amount of solids in the coating may vary based upon the coating process used. For example, if the coating is formed by curtain coating, the solid percentage may be from about 0.1-3%, more preferably from about 0.3-1.5%, and still more preferably from about 0.6 to 0.8% before and/or after drying and/or heat treating (e.g., after drying, but prior to heat treating). If the coating is formed by spin coating, the amount of solids may be from about 0.5-10%, more preferably from about 1-8%, and still more preferably from about 2 to 4%, before and/or after drying and/or heat treating (e.g., after drying, but prior to heat treating), in certain example embodiments. The amount of solids may be from about 0.1-3%, more preferably from about 0.2-2.0%, and still more preferably from about 0.5 to 0.9% if the coating is formed via a draw down bar process, before and/or after drying and/or heat treating (e.g., after drying, but prior to heat treating), in some examples. In certain example embodiments, if the coating is formed by roller methods, the amount of solids may be from about 1-20%, more preferably from about 3-15%, and still more preferably from about 6 to 10% before and/or after drying and/or heat treating (e.g., after drying, but prior to heat treating). The aforesaid percentages are all given with respect to weight.

The solids in the coating may comprise silica and the porous nanoparticles. In certain example embodiments, the porous nanoparticles may comprise from about 25 to 75%, more preferably from about 35 to 65%, and most preferably about 50% of the total solid content (by weight) of the coating/layer after drying prior to any heat treatment such as thermal tempering. Similarly, the silica may comprise from about 25 to 75%, more preferably from about 35 to 65%, and most preferably about 50% of the total solid content (by weight) of the coating/layer after drying prior to any heat treatment such as thermal tempering.

FIG. 6 is a partially schematic cross-sectional view of example AR coating layer comprising metal oxide particles and porous nanoparticles in a matrix according to certain example embodiments. In FIG. 6, metal/metal oxide particles (e.g., Si, SiO₂, Ti, TiO₂, Al, AlO₂, etc.) are represented with reference numeral 5. The pores in the porous nanoparticles are identified with reference numeral 7. The pores created by the spacing between the metal oxide particles and the porous nanoparticles are indicated with reference numeral 8. Thus, FIG. 6 illustrates (e.g., in an exaggerated fashion) how the porosity of anti-reflective coating layer 4 may in certain example embodiments be a result of (1) the geometric package of porous nanoparticles and metal oxide particles in a metal oxide based matrix (e.g., spaces 8 between multiple particles 5 and/or spaces 8 between particles 5 and porous nanoparticles), and/or (2) the intrinsic pore size of a porous nanoparticle (e.g., pores 7).

In certain example embodiments, the glass substrate 1 comprising the layer 4 comprising a silica and porous nanoparticle based matrix may be thermally and/or chemically tempered. These treatments may increase the strength of the glass. In certain example embodiments, heat treating/tempering may be performed at a temperature of at least about 500° C., more preferably at least about 560° C., even more preferably at least about 580 or 600° C., and most preferably the coated substrate is tempered at a temperature of at least about 625-700° C., for a period of from about 1 to 20 min, more preferably from about 2 to 10 min, and most preferably for about 3 to 5 minutes. In other embodiments, heating may be performed at any temperature and for any duration sufficient to cause the layer to reach the desired strength.

The thickness of the coating layer and its refractive index may be modified by the solid amount and composition of the sols. The pore size and/or porosity of the AR coating may be changed by (1) the geometric design of the pore shape and/or size, and/or the surface morphology of the porous nanoparticles used (e.g., whether one or more materials are used for the porous nanoparticles, and the types and/or amount of surface morphologies used), and/or (2) the overall amount of the porous nanoparticle and metal alkoxides used.

In certain example embodiments, nanoporous and/or mesoporous nanoparticles may be made from silicate materials. In certain embodiments these materials may have a refractive index close to that of a glass substrate. In other example embodiments, porous nanoparticles may also be prepared from metal oxides and/or transition metal oxides, such as oxides of or including any of Si, Ti, Al, Fe, V, Zn, V, Zr, Sn, phosphate, etc.

For example, the porous nanoparticles may comprise MCM-41, MCM-48, and/or MCM-50, with ordered hexagonal, cubic, and lamellar structures, respectively. In certain embodiments, the pore size may be from about 0.5 to 20 nm, more preferably from about 1 to 10 nm, and most preferably from about 1.5 to 3 nm. However, in some cases, the pore size could be expanded with the help of a swelling agent. For example, with a swelling agent, the pore size may be expanded to up to 20 nm, in some instances.

Another exemplary embodiment includes nanoparticles comprising SBA-15 and SBA-16, with hexagonal and cubic structures, respectively. The pore size of SBA-15 and/or SBA-16 is from about 2 to 30 nm, more preferably from about 3 to 20 nm, and most preferably from about 4 to 14 nm, without a swelling agent in certain example embodiments. In further example embodiments, the well of the pores may comprise amorphous silica that may contain various heteroelements, such as Al, Ti, Zr, Cu, Fe, Zn, Zr, P, and the like.

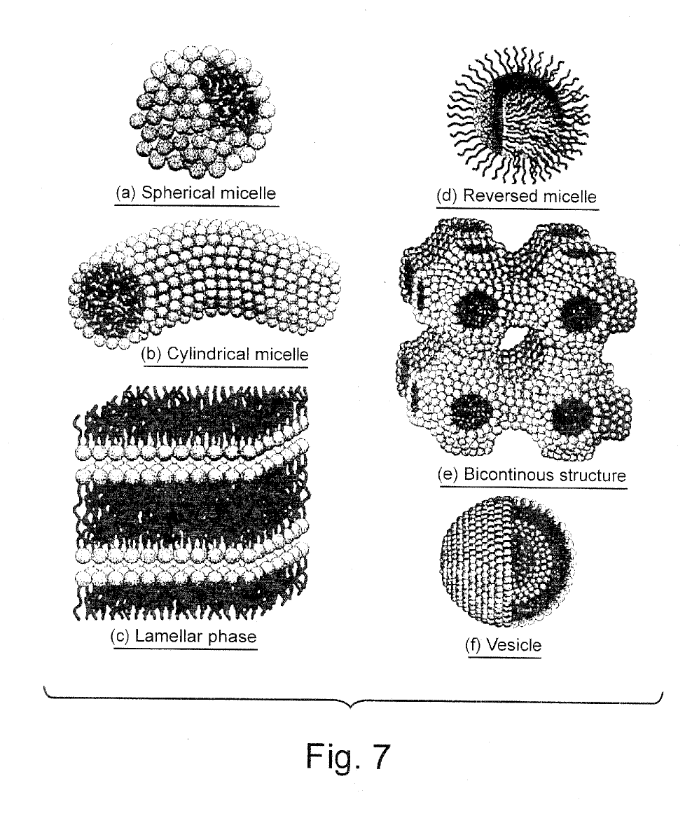

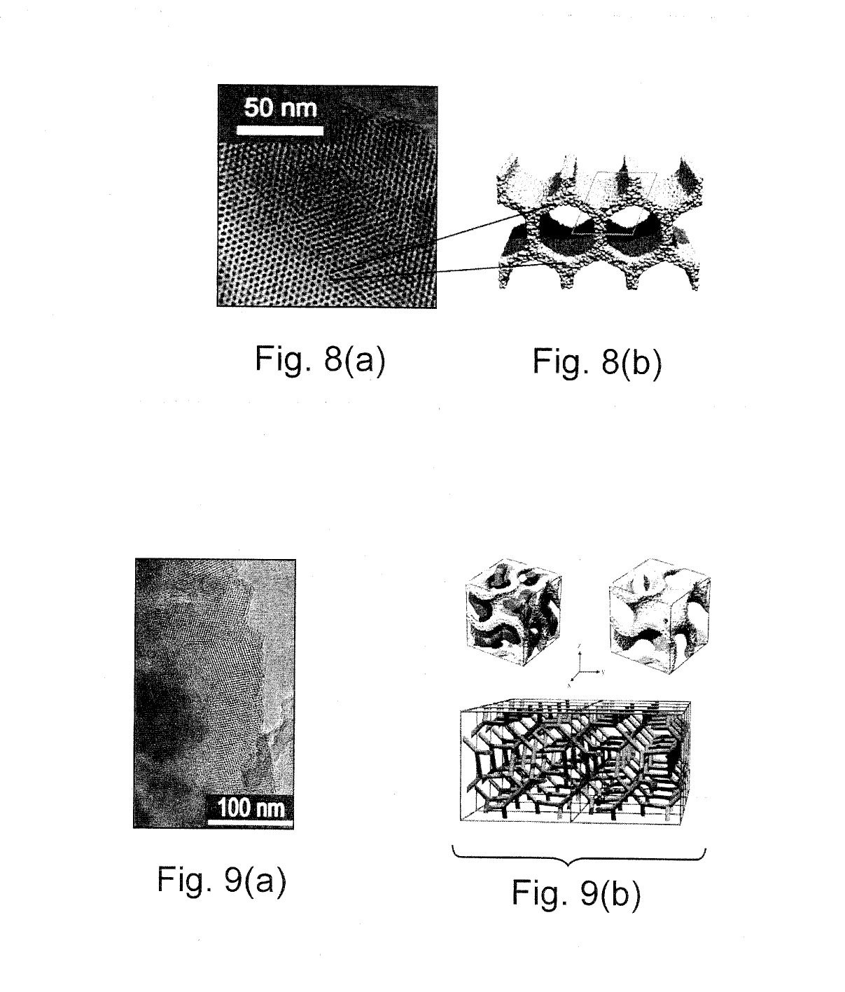

In certain example embodiments, the nanoporous and/or mesoporous nanoparticles may comprise surface morphologies that are hexagonal, cubic, lamellar, and/or tubular. In certain example embodiments, the surface morphologies may be related to the shape(s) of micelles used in a surfactant-based solution. Example micelle shapes are illustrated in FIG. 7. Example surface morphologies are illustrated in FIGS. 8-11. The various surface morphologies of the porous nanoparticles may be generated in different ways. The formation of the various surface morphologies based on various micelle shapes is described in detail below.

An example technique for generating varying surface morphologies for porous nanoparticles may be related to the shape of micelles used in a pre-cursor solution. In certain example embodiments, the morphology of nano- and/or meso-porous materials may be generated by different shapes of micelles. A micelle generally refers to an aggregate of surfactant molecules dispersed in a liquid colloid. A typical micelle in aqueous solution forms an aggregate with the hydrophilic “head” regions in contact with surrounding solvent, sequestering the hydrophobic single tail regions in the micelle centre.

For example, when a surfactant is dissolved in solvent, as the concentration of surfactant moves toward the critical micelle concentration (CMC), the micelles may be built up. In certain example embodiments, micelles may only form when the concentration of surfactant is greater than the CMC, and the temperature of the system is greater than the critical micelle temperature, or Krafft temperature. The formation of micelles can be understood using thermodynamics: micelles can form spontaneously because of a balance between entropy and enthalpy. In water, the hydrophobic effect is the driving force for micelle formation, despite the fact that assembling surfactant molecules together reduces their entropy. At very low concentrations of the lipid, only monomers are present in true solution. As the concentration of the lipid is increased, a point is reached at which the unfavorable entropy considerations, derived from the hydrophobic end of the molecule, become dominant. At this point, the lipid hydrocarbon chains of a portion of the lipids must be sequestered away from the water. Therefore, the lipid starts to form micelles. Broadly speaking, above the CMC, the entropic penalty of assembling the surfactant molecules is less than the entropic penalty of caging the surfactant monomers with water molecules. In certain examples, the enthalpy may also be considered, e.g., including the electrostatic interactions that occur between the charged parts of surfactants.

In certain example embodiments, the behavior of the micelles, and accordingly the morphology of the nanoparticles, may be dependent upon the characteristics of the surfactant and/or characteristics of the solution. Example characteristics of the surfactant that may have an effect on the morphology of the nanoparticles include whether the surfactant is ionic or non-ionic; whether it comprises small molecular compounds, polymers, etc.; whether it is linear or a network; and the like. Furthermore, in certain cases, the micelles may be spherical, cylindrical, or lamellar shaped. FIG. 7 illustrates different example shapes that micelles may have.

FIG. 7(a) illustrates a spherical micelle, FIG. 7(b) illustrates a cylindrical micelle, FIG. 7(c) illustrates a micelle in the lamellar phase, FIG. 7(d) illustrates reversed micelle, FIG. 7(e) illustrates a bicontinuous structure, and FIG. 7(f) illustrates a vesicle. These various shapes of micelles illustrate different example morphologies that micelles developed by surfactants may possess.

In certain example embodiments, during the process of making a layer comprising porous materials and metal alkoxides, tetraethyl orthosilicate (TEOS) may be added to the solution. In some instances, a network of TEOS may be generated around the micelles after the TEOS has been hydrolyzed and/or condensed. In some cases, in order to generate the desired pore structure, after the micelles have been formed in varying shapes, calcination may be performed. During the calcination step, the micelles may be removed and the materials may comprise pores having the exact shape of the space the micelle(s) previously occupied, in some instances. In certain example embodiments, this may cause nanoporous and/or mesoporous nanoparticles to be formed.

In certain example embodiments, the surface morphologies may be related to the shape(s) of micelles used in a surfactant-based solution. In certain example embodiments, the formation of the micelles may depend upon the type of surfactant used and properties of the surfactant, as well as the properties of the solution, such as the pH, temperature, solvent, aging time, swelling agent, and the like. Thus, the foregoing factors may be used to determine the ultimate surface morphology of the porous nanoparticles, in certain example embodiments.

In certain example embodiments, the nanoporous and/or mesoporous nanoparticles may comprise surface morphologies that are hexagonal, cubic, lamellar, and/or tubular.

FIG. 8(a) illustrates a TEM image of an example honeycomb structure (e.g., MCM-41), and FIG. 8(b) illustrates a schematic representation of a hexagonal-shaped one-dimensional pore.

FIGS. 9(a)-(b) illustrate an example cubic structured-morphology for porous nanoparticles. FIG. 9(a) illustrates a TEM image of an example cubic structure (e.g., MCM-48), and FIG. 9(b) illustrates a schematic representation of a cubic-shaped pore.

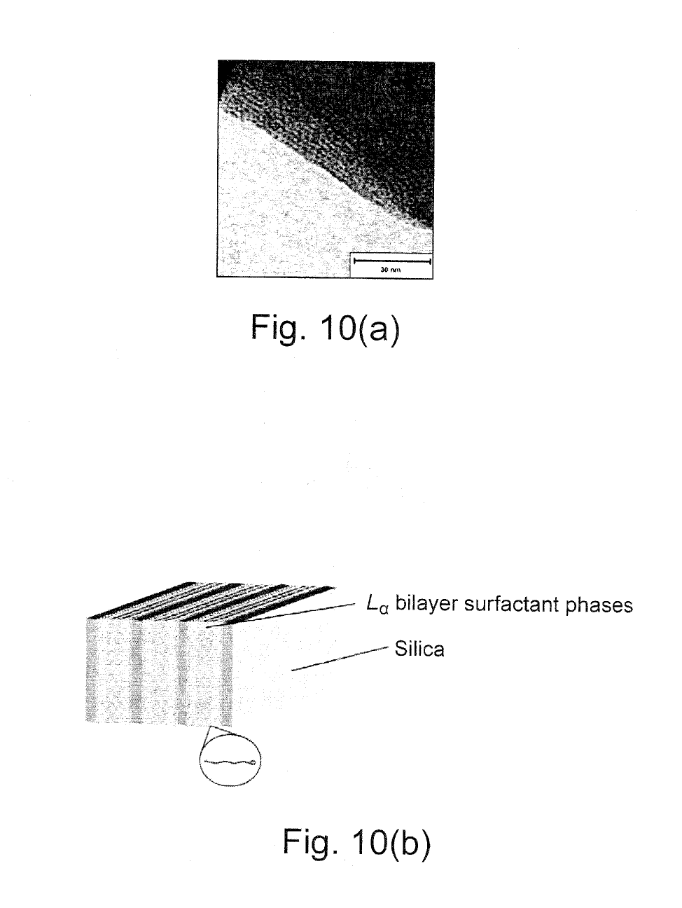

FIGS. 10(a)-(b) illustrate an example lamellar structured-morphology for porous nanoparticles. FIG. 10(a) illustrates a TEM image of the lamellar structure of mesoporous materials. FIG. 10(b) shows a schematic representation of the lamellar-shaped pore produced by certain surfactant approaches.

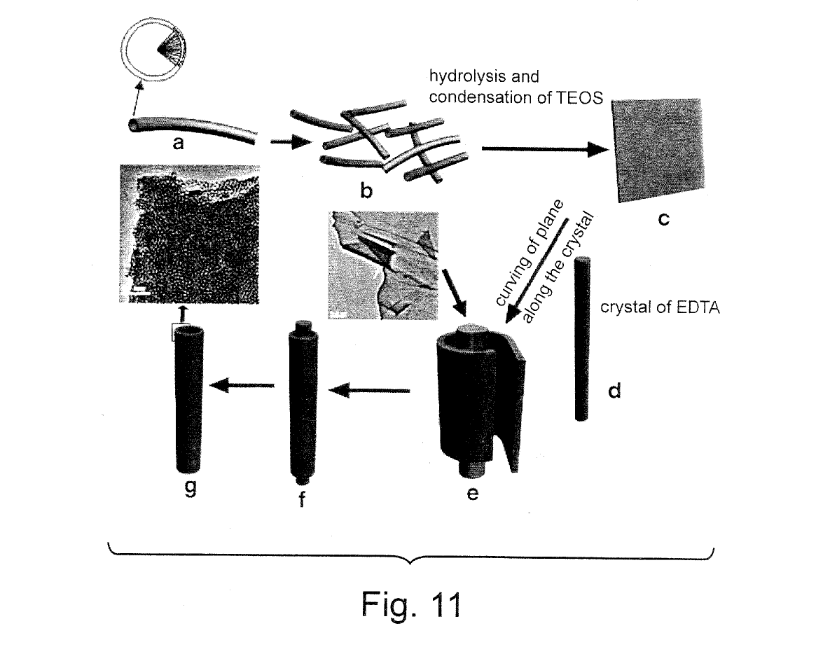

FIG. 11 illustrates an example tubular structured morphology. FIG. 11 also illustrates an example mechanism of synthesis for a tubular-structured porous nanoparticle. Hollow silica tubes with mesoporous walls may be developed using ethylenediaminetetraactic acid disodium salt (Na2EDTA) as a controller in certain example embodiments. Na2EDTA can function as the catalyst for the hydrolysis and/or condensation of a silane, such as TEOS, in some cases. Furthermore, Na2EDTA may also be used in co-assembling micelles, for example, with cetyltrimethylammonium bromide (CTAB), to generate the desired mesoporous structure, in some cases. Crystallized Na2EDTA may also be used as the template for inducing the formation of mesoporous materials comprising a tubular morphology, in certain examples.

In FIG. 11, (a) and (b) show the worm-like co-assembly of micelle composites by Na2EDTA and CTAB by electrostatic interaction; (c) shows a patch developed from the composites joining together (e.g., through hydrolysis and/or condensation of TEOS or another solvent); (d) represents a needle-like crystal of EDTA separate out from an ethanol-water system; (e) shows the plane curving along the EDTA crystal; (f) illustrates a tube containing a needle-like EDTA crystal; and (g) illustrates a tube comprising a wall of mesoporous silica after removal of the EDTA crystal.

In certain example embodiments, a porous silica anti-reflective layer may be formed by the methods described herein. This porous silica anti-reflective layer may advantageously have pores that are very small in at least diameter (e.g., on the scale of 1 to 2 nm), and of various shapes, enabling the coating to have an improved durability and optical performances, in certain example embodiments. Furthermore, the pores may be formed so as to be closed and/or tunnel-like, depending on the desired properties (e.g., by selectively choosing the surface morphology of the porous nanoparticles based on the properties desired).

In certain examples, the pores in the antireflection coating may be formed from gaps between nanoparticles in the layer (e.g., the geometric package). In these cases, the pore size and/or distribution of pore size may be controlled by the amount of nanoparticles in the sol, and/or the geometric shape of the nanoparticles. Furthermore, in some examples, the pore sizes in the AR coating may be impacted by the process speed, the solvents used, and/or the process temperatures. In certain example embodiments, the pores within the nanoparticles themselves (e.g., the pores formed from extraction of the micelles through calcination, etc.) remain relatively unchanged throughout the process of forming the AR coating. In certain example embodiments, the introduction of a nanoparticle comprising a nano- and/or meso-porous structure in an AR coating may enable the adjustment or pore structure in order to improve transmittance of the coated article.

In certain example embodiments, porous nanoparticles and carbon-inclusive structures such as fullerenes may be included in the sol gel. In certain example embodiments, the carbon-inclusive structures may be partially or fully burned off during heat treatment, leaving behind pores (e.g., empty spaces) that may assist in tuning the porosity of the final coating. Methods of utilizing carbon-inclusive structures to create a desired pore size are described in co-pending and commonly assigned U.S. application Ser. No. 13/360,898, filed on the same day as the instant application. The entire contents of this application are hereby incorporated herein by reference. In certain examples, the use of fullerene structures and porous nanoparticles may enable the porosity and/or pore size of the final AR coating may be tuned to an even finer degree.

In certain example embodiments, the refractive index of the anti-reflective layer may be from about 1.15 to 1.40, more preferably from about 1.17 to 1.3, and most preferably from about 1.20 to 1.26, with an example refractive index being about 1.22. In certain examples, the thickness of a single-layer anti-reflective coating may be from about 50 to 500 nm, more preferably from about 75 to about 250 nm, and most preferably from about 120 to 160 nm, with an example thickness being about 140 nm. However, in certain instances, the refractive index may be dependent upon the coating's thickness. In certain examples, a thicker anti-reflective coating will have a higher refractive index, and a thinner anti-reflective coating may have a lower refractive index. Therefore, a thickness of the coating may vary based upon the desired refractive index.

In certain example embodiments, to achieve a desirable refractive index, the porosity of the anti-reflective coating may be from about 15 to 50%, more preferably from about 20 to 45%, and most preferably from about 27.6 to 36%. The porosity is a measure of the percent of empty space within the coating layer, by volume. In certain example embodiments, the pore size may be as small as 1 nm, or even less. The pore size may range from about 0.1 nm to 50 nm, more preferably from about 0.5 nm to 25 nm, even more preferably from about 1 nm to 20 nm, and most preferably from about 2.4 to 10.3 nm. Pore size, at least in terms of diameter or major distance, may be as small as the smallest porous nanoparticle will permit. Higher porosity usually leads to lower index but decreased durability. However, it has been advantageously found that by utilizing porous nanoparticles with small pores, a desired porosity (in terms of % of empty space in the coating) may be obtained with a reduced overall pore size, thereby increasing the durability of the coating.

The porous silica-based layer may be used as a single-layer anti-reflective coating in certain example embodiments. However, in other embodiments, under layers, barrier layers, functional layers, and/or protective overcoats may also be deposited on the glass substrate, over or under the anti-reflective layer described herein in certain examples.

A porous silica-based anti-reflective layer according to certain example embodiments may be used as a broadband anti-reflective coating in electronic devices and/or windows. However, coatings as described herein may also effectively reduce the reflection of visible light. Thus, in addition to photovoltaic devices and solar cells, for example, these coated articles may be used as windows, in lighting applications, in handheld electronic devices, display devices, display cases, monitors, screens, TVs, and the like.

Although TEOS is given as an example silica-precursor used to form a silica-based matrix, almost any other silica precursor may be used in different example embodiments. In certain cases, any suitable a silicon-based compound comprising Si with four bond sites (e.g., a silane) may be used. Although a porous silica-based anti-reflective coating is described in many of the examples, a porous layer of any composition may be made according to certain methods disclosed herein. For example, if a glass substrate were treated so as to have a higher index of refraction at its surface, and a porous layer with a higher index of refraction could therefore be used to sufficiently reduce reflection, a titanium oxide and/or aluminum oxide-based matrix with porous nanoparticles that help to produce a porous layer could also be made. In still further example embodiments, other metal oxide and/or alkoxide precursors may be used. Porous coatings of other metal oxide and/or alkoxide precursors may be used for other applications. For example, if the coating is used on a substrate with an index of refraction different from that of glass, other metal oxides may be reacted with reactive groups attached to other types of porous nanoparticles to form other types of metal oxide-porous nanoparticle matrices. The selection of materials also may be based, in part, on the amount of reflection reduction desired. These matrices may subsequently be heated/tempered in certain embodiments. In other words, porous metal oxide-based matrices of any metal, for any purpose, may be formed by utilizing the tunable pore size/porosity obtainable by porous (e.g., nano- and/or meso-porous) nanoparticles.

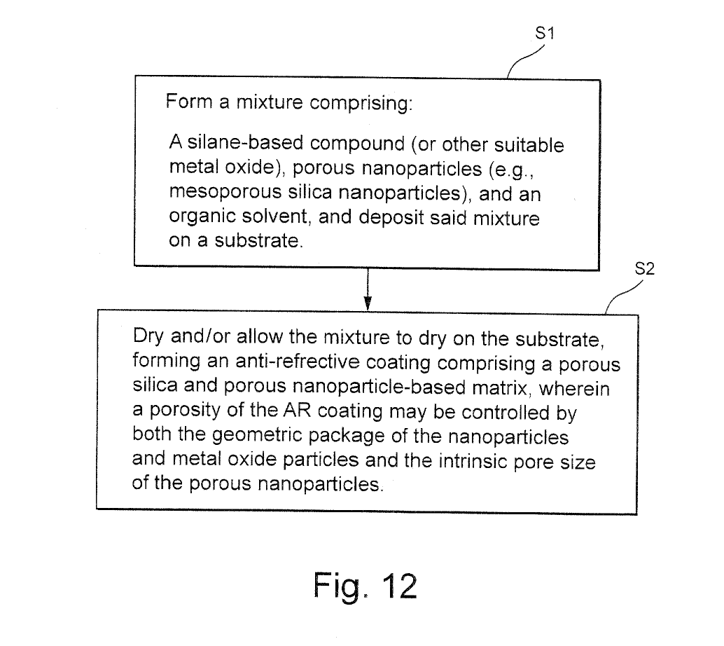

FIG. 12 is a flowchart illustrating an example method of making a porous metal oxide-based layer (e.g., a porous silica-based layer) in accordance with certain example embodiments. In S1, a coating solution comprising a silane-based compound, porous nanoparticle(s) with at least one (but possibly more) hydroxyl group may be deposited on a glass substrate. In certain cases, the coating solution may be deposited by any appropriate sol gel deposition technique.

In S2, the coating is dried, and/or allowed to dry, and any remaining solvent, water, catalyst, unreacted reagent, and/or other by-products may be evaporated. A layer comprising a matrix of silica and porous nanoparticles remains.

In an option step that is not shown, the coated article may be heat treated (e.g., thermally tempered) such that the any carbon-based compounds remaining in the layer (e.g., from solvents, R groups, or the like) combust, and diffuse out of the layer, resulting in a silica-based matrix with a porosity determined by the size of pores between the non-porous silica molecules as well as by the size of the pores in the porous nanoparticles themselves. The layer may be used as a single-layer anti-reflective coating in certain example embodiments. However, in other embodiments, under layers, barrier layers, functional layers, and/or protective overcoats may also be deposited on the glass substrate, over or under the anti-reflective layer described herein in certain examples.

In certain example embodiments, the method may further comprise an intermediate heating step between drying and heat treating. In certain examples, particularly where solvents and/or silane-based compounds with higher molecular weights are used, an intermediate heating step may help ensure all of the by-products and/or unused reactants or solvents are fully evaporated prior to any relocation of the coated article for tempering that may be necessary.

In certain example embodiments, the sol may be formed by a first party and then applied by a second party. In certain example embodiments, a third party may build the thus-coated article into an intermediate or final product. Thus, it will be appreciated that certain example embodiments may involve a first party making a sol, having a manufacturer apply the coating to a large stock sheet or substrate, and then forwarding the large coated stock sheet or substrate to a fabricator for cutting or sizing, and/or for incorporation into an intermediate or final product. In certain example embodiments, heat treating may be performed after optional cutting and/or sizing steps (e.g., by a fabricator).

As explained above, substrate 1 may be a clear, green, bronze, or blue-green glass substrate from about 1.0 to 10.0 mm thick, and more preferably from about 1.0 mm to 3.5 mm thick. In certain electronic device applications, the glass substrate may be thinner. In other example embodiments, particularly in solar and/or photovoltaic applications, a low-iron glass substrate such as that described in U.S. Pat. Nos. 7,893,350 or 7,700,870, which are hereby incorporated by reference, may be used.

Although certain sizes have been provided herein and expressed in terms of diameters, it is noted that the particles may not always be circular or spherical. Thus, the term diameter may instead refer to a major distance across a particle, e.g., when particles are not perfectly circular or spherical. It also is noted that although certain sizes are provided, particles may come in distributions in which there is some minor variation in the sizing of the individual elements. Thus, the sizes specified for a given distribution may be considered mean sizes and/or the particles in a distribution may comprise or consist essentially of elements within a particular size range (e.g., close to the average).

While a layer, layer system, coating, or the like, may be said to be “on” or “supported by” a substrate, layer, layer system, coating, or the like, other layer(s) may be provided therebetween. Thus, for example, the coatings described herein may be considered “on” and “supported by” the substrate and/or other coatings even if other layer(s) are provided therebetween.

Certain terms are prevalently used in the glass coating art, particularly when defining the properties and solar management characteristics of coated glass. Such terms are used herein in accordance with their well known meaning (unless expressly stated to the contrary). For example, the terms “heat treatment” and “heat treating” as used herein mean heating the article to a temperature sufficient to achieve thermal tempering, bending, and/or heat strengthening of the glass inclusive article. This definition includes, for example, heating a coated article in an oven or furnace at a temperature of least about 560, 580 or 600 degrees C. for a sufficient period to allow tempering, bending, and/or heat strengthening, and also includes the aforesaid test for thermal stability at about 625-700 degrees C. In some instances, the HT may be for at least about 4 or 5 minutes, or more.

In certain example embodiments, there is provided a method of making a coated article including a broadband anti-reflective coating comprising porous silica disposed, directly or indirectly, on a glass substrate. A coating is formed, directly or indirectly, on the glass substrate by disposing on the glass substrate a coating solution formed from a silane, mesoporous silica nanoparticles comprising at least one functional group, and a solvent. The coating is dried and/or the coating is allowed to dry, so as to form an anti-reflective coating comprising a non-porous silica and mesoporous silica nanoparticle based matrix on the glass substrate. The coating includes a porosity defined by first and second pore sizes, the first pore size being created as a result of a geometric package of mesoporous silica nanoparticles and metal oxide particles in the matrix, and the second pore size being created by virtue of a pore size of the mesoporous silica nanoparticles.

In addition to the features of the preceding paragraph, in certain example embodiments, a porosity of the anti-reflective coating may be from about 20 to 45%.

In addition to the features of either of the two preceding paragraphs, in certain example embodiments, the mesoporous silica nanoparticles may have an average pore size of from about 1 to 100 nm.

In addition to the features of any of the three preceding paragraphs, in certain example embodiments, the mesoporous silica nanoparticles may have an average pore size of from about 2 to 50 nm.

In addition to the features of any of the four preceding paragraphs, in certain example embodiments, the mesoporous silica nanoparticles may have an average pore size of from about 2 to 25 nm.

In addition to the features of any of the five preceding paragraphs, in certain example embodiments, the mesoporous silica nanoparticles may have an average pore size of from about 2.4 to 10.3 nm.

In addition to the features of any of the six preceding paragraphs, in certain example embodiments, the at least one functional group of the mesoporous silica nanoparticles may comprise a hydroxyl group.

In addition to the features of any of the seven preceding paragraphs, in certain example embodiments, the silane may comprise tetraethyl orthosilicate (TEOS).

In addition to the features of any of the eight preceding paragraphs, in certain example embodiments, the solvent may comprise ethanol.

In addition to the features of any of the nine preceding paragraphs, in certain example embodiments, a refractive index of the anti-reflective coating may be from about 1.20 to 1.26.

In addition to the features of any of the ten preceding paragraphs, in certain example embodiments, a thickness of the anti-reflective coating may be from about 120 to 160 nm.

In certain example embodiments, a method of making an anti-reflective coating is provided. A coating solution comprising at least a metal oxide, porous nanoparticles, and a solvent is provided. The coating solution is disposed on a glass substrate so as to form a coating comprising a metal oxide and porous nanoparticle-based matrix. The substrate with the coating thereon is dried and/or heat treated, so as to form a coating comprising a porous metal oxide.

In addition to the features of the preceding paragraph, in certain example embodiments, the metal oxide may comprise a silane.

In addition to the features of either of the two preceding paragraphs, in certain example embodiments, the porous nanoparticles may comprise mesoporous silica nanoparticles.

In addition to the features of any of the three preceding paragraphs, in certain example embodiments, at least some of the porous nanoparticles may comprise a functional group.

In addition to the features of the preceding paragraph, in certain example embodiments, the functional group may be a hydroxyl group.

In addition to the features of any of the five preceding paragraphs, in certain example embodiments, the heat treating may be performed at a temperature of at least about 560° C.

In certain example embodiments, a coated article is provided. A glass substrate is provided. A coating is supported by the glass substrate, with the coating comprising a matrix comprising mesoporous silica nanoparticles and silica. The coating includes a porosity defined by first and second pore sizes, the first pore size being created as a result of a geometric package of mesoporous silica nanoparticles and metal oxide particles in the matrix, and the second pore size being created by virtue of a pore size of the mesoporous silica nanoparticles.

In addition to the features of the preceding paragraph, in certain example embodiments, at least some of the porous nanoparticles may have a pore size of less than about 2 nm.

In addition to the features of either of the two preceding paragraphs, in certain example embodiments, the porous nanoparticles may comprise at least one of mesoporous silica, mesoporous titanium oxide, and mesoporous aluminum oxide.

In certain example embodiments, coated article is provided. A glass substrate with an anti-reflective coating disposed thereon is provided. The anti-reflective coating comprises porous nanoparticles and silica.

In addition to the features of the preceding paragraph, in certain example embodiments, the anti-reflective coating may have a porosity of from about 27.6 to 36%.

In certain example embodiments, there is provided a method of making a coated article including an anti-reflective coating comprising porous silica, directly or indirectly, on a glass substrate. A coating solution comprising a silane, porous nanoparticles, and a solvent is formed. A coating is formed, directly or indirectly, on the glass substrate by disposing the coating solution on the glass substrate. The coating is dried and/or the coating is allowed to dry so as to form a coating comprising silica and a matrix comprising the porous nanoparticles on the glass substrate, so as to form an anti-reflective coating comprising a silica-based matrix on the glass substrate.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a coated article including a broadband anti-reflective coating comprising porous silica disposed, directly or indirectly, on a glass substrate, the method comprising:
forming a coating, directly or indirectly, on the glass substrate by disposing on the glass substrate a coating solution formed from a silane, mesoporous silica nanoparticles comprising at least one functional group, and a solvent; and
drying the coating and/or allowing the coating to dry so as to form an anti-reflective coating comprising a non-porous silica and mesoporous silica nanoparticle based matrix on the glass substrate,
wherein the coating includes a porosity defined by first and second pore sizes, the first pore size being created as a result of a geometric package of mesoporous silica nanoparticles and metal oxide particles in the matrix, and the second pore size being created by virtue of a pore size of the mesoporous silica nanoparticles.

2. The method of claim 1, wherein a porosity of the anti-reflective coating is from about 20 to 45%.

3. The method of claim 1, wherein the mesoporous silica nanoparticles have an average pore size of from about 1 to 100 nm.

4. The method of claim 1, wherein the mesoporous silica nanoparticles have an average pore size of from about 2 to 50 nm.

5. The method of claim 1, wherein the mesoporous silica nanoparticles have an average pore size of from about 2 to 25 nm.

6. The method of claim 1, wherein the mesoporous silica nanoparticles have an average pore size of from about 2.4 to 10.3 nm.

7. The method of claim 1, wherein the at least one functional group of the mesoporous silica nanoparticles comprises a hydroxyl group.

8. The method of claim 1, wherein the silane comprises tetraethyl orthosilicate (TEOS).

9. The method of claim 1, wherein the solvent comprises ethanol.

10. The method of claim 1, wherein a refractive index of the anti-reflective coating is from about 1.20 to 1.26.

11. The method of claim 1, wherein a thickness of the anti-reflective coating is from about 120 to 160 nm.

12. A method of making an anti-reflective coating, the method comprising:
providing a coating solution comprising at least a metal oxide, porous nanoparticles, and a solvent;
disposing the coating solution on a glass substrate so as to form a coating comprising a metal oxide and porous nanoparticle-based matrix; and
drying and/or heat treating the substrate with the coating thereon, so as to form a coating comprising a porous metal oxide.

13. The method of claim 12, wherein the metal oxide comprises a silane.

14. The method of claim 12, wherein the porous nanoparticles comprise mesoporous silica nanoparticles.

15. The method of claim 14, wherein at least some of the porous nanoparticles comprise a functional group.

16. The method of claim 15, wherein the functional group is a hydroxyl group.

17. The method of claim 12, wherein the heat treating is performed at a temperature of at least about 560° C.

18. A coated article comprising:
a glass substrate; and
a coating supported by the glass substrate, the coating comprising a matrix comprising mesoporous silica nanoparticles and silica,
wherein the coating includes a porosity defined by first and second pore sizes, the first pore size being created as a result of a geometric package of mesoporous silica nanoparticles and metal oxide particles in the matrix, and the second pore size being created by virtue of a pore size of the mesoporous silica nanoparticles.

19. The coated article of claim 18, wherein at least some of the porous nanoparticles have a pore size of less than about 2 nm.

20. The coated article of claim 18, wherein the porous nanoparticles comprise at least one of mesoporous silica, mesoporous titanium oxide, and mesoporous aluminum oxide.

21. A coated article comprising:
a glass substrate with an anti-reflective coating disposed thereon;
wherein the anti-reflective coating comprises porous nanoparticles and silica.

22. The coated article of claim 21, wherein the anti-reflective coating has a porosity of from about 27.6 to 36%.

23. A method of making a coated article including an anti-reflective coating comprising porous silica, directly or indirectly, on a glass substrate, the method comprising:
forming a coating solution comprising a silane, porous nanoparticles, and a solvent;
forming a coating, directly or indirectly, on the glass substrate by disposing the coating solution on the glass substrate; and
drying the coating and/or allowing the coating to dry so as to form a coating comprising silica and a matrix comprising the porous nanoparticles on the glass substrate, so as to form an anti-reflective coating comprising a silica-based matrix on the glass substrate.
